(19) United States
(12) Patent Application Publication
(10) Pub. No.: US 2025/0053901 A1
(43) Pub. Date: Feb. 13, 2025

(54) INFORMATION PROCESSING DEVICE

(71) Applicant: Toyota Jidosha Kabushiki Kaisha, Toyota-shi (JP)

(72) Inventor: Naoki MIURA, Utsunomiya-shi (JP)

(73) Assignee: Toyota Jidosha Kabushiki Kaisha, Toyota-shi (JP)

(21) Appl. No.: 18/756,001

(22) Filed: Jun. 27, 2024

(30) Foreign Application Priority Data
Aug. 10, 2023 (JP) 2023-131550

(51) Int. Cl. G06Q 10/0631

(52) U.S. Cl. CPC G06Q 10/06315; G06Q 10/06311

(57) ABSTRACT

A control unit configured to execute: accepting a designation of a desired work that is a work for a vehicle desired by a user; determining whether a first facility associated with the user is capable of corresponding to a desired work; outputting information for recommending a first facility as a facility for performing a desired work to a terminal associated with the user in response to determining that the first facility is capable of corresponding to a desired work; and outputting information for recommending a second facility other than the first facility as a facility for performing a desired work to a terminal associated with the user in response to determining that the first facility is not capable of corresponding to a desired work.

### CROSS-REFERENCE TO RELATED APPLICATION

This application claims priority to Japanese Patent Application No. 2023-131550 filed on Aug. 10, 2023, incorporated herein by reference in its entirety.

### BACKGROUND

### 1. Technical Field

The present disclosure relates to an information processing device.

### 2. Description of Related Art

A system is known in which a manufacturer and a dealer each have a homepage on the Internet, and when a general consumer accesses the homepage of the manufacturer, all registered dealers are presented, and when the general consumer accesses the homepage of the manufacturer via the homepage of the dealer, only the dealer of that homepage is presented (see, for example, Japanese Unexamined Patent Application Publication No. 2002-099753 (JP 2002-099753 A)).

### SUMMARY

An object of the present disclosure is to propose a facility suitable for desired work to a user of a vehicle.

An aspect of the present disclosure is an information processing device including a control unit configured to execute: receiving designation of desired work, the desired work being work on a vehicle that is desired by a user; determining whether a first facility associated with the user is able to handle the desired work; outputting, in response to the control unit determining that the first facility is able to handle the desired work, information for recommending the first facility as a facility for performing the desired work, to a terminal related to the user; and outputting, in response to the control unit determining that the first facility is not able to handle the desired work, information for recommending a second facility other than the first facility as the facility for performing the desired work, to the terminal related to the user.

The present disclosure can also be regarded as an information processing method in which a computer executes processing of the above information processing device. The present disclosure can also be regarded as an information processing program for causing a computer to execute the above information processing method or a non-transitory storage medium storing the information processing program.

According to the present disclosure, it is possible to propose a facility suitable for desired work to the user of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration example of a system according to an embodiment;

FIG. 2 is a diagram illustrating an exemplary transition of a suggested Web page according to the embodiment;

FIG. 3 is a diagram illustrating exemplary information stored in a user information DB and a facility information DB;

FIG. 4 is a diagram illustrating URL of the input page of user via the web browser of the user terminal.

### DETAILED DESCRIPTION OF EMBODIMENTS

When the user of the vehicle desires, for example, maintenance of the vehicle, it is conceivable that the user requests maintenance from the store where the vehicle is purchased. However, some stores that sell vehicles may not have equipment for maintenance of vehicles. In such a case, it is conceivable that the user searches for a facility capable of performing maintenance of the vehicle and requests the facility to perform maintenance. However, such facilities may not be found immediately. In addition, it takes time and effort for the user himself/herself to confirm whether or not the user corresponds to a desired work.

On the other hand, in the information processing device according to the present disclosure, the control unit receives a designation of a desired work, which is a work for the vehicle desired by the user. In one embodiment, the control unit may output a user interface window including an input field of a work (desired work) desired by the user through a Web browser of a terminal related to the user, and cause the input field to input a desired work. The terminal associated with the user may be a computer carried by the user, such as a smartphone, or may be a computer mounted on a vehicle of the user. The desired operation may be, for example, a statutory inspection, a repair, a tire replacement, a battery replacement, a brake pad replacement, an item attachment, or a software update.

In addition, the control unit determines whether or not the first facility associated with the user is capable of handling the desired work. The first facility is, for example, a facility stored in association with the user in the storage unit. The first facility is, for example, a store in which a vehicle is sold to a user, a facility in which the user has previously requested maintenance of the vehicle, a facility in which the user has made a purchase of the vehicle purchased on Web, a facility in which the user has made a contract for leasing on Web, or a facility in which the user has made a purchase contract or a lease contract for the vehicle. Whether or not the first facility can deal with the desired work may be stored in the storage unit.

In addition, when determining that the first facility is capable of handling the desired work, the control unit outputs information for recommending the first facility as a facility for performing the desired work to the terminal associated with the user. In one embodiment, the control unit may output a user interface window including information for recommending the first facility through Web browsers of the terminals associated with the user. The user interface screen may be configured to display the name of the first facility, the location of the first facility, and the contact information of the first facility.

On the other hand, in response to determining that the first facility is not capable of handling the desired work, the control unit outputs information for recommending a second facility other than the first facility as a facility for performing the desired work to a terminal associated with the user. In one embodiment, the control unit may output a user interface window including information for recommending the second facility through Web browsers of the terminals associated with the user. The user interface screen may be configured to display the name of the second facility, the location of the second facility, and the contact information of the second facility.

The second facility is a facility capable of performing a desired work other than the first facility. The second facility may be, for example, a facility associated with the first facility. The second facility may be, for example, a facility of the same capital as the first facility, a group company of a company operating the first facility, or a facility of an affiliate company. For example, the second facility may be a facility that is also beneficial to a company that operates the first facility. The second facility may be a facility registered for proposal instead of the first facility. In this way, the second facility is a facility with some relationship to the first facility or a facility associated with the first facility.

In this way, the user of the vehicle can know the facility (the first facility or the second facility) capable of responding to the desired work by specifying the work desired by the user. As a result, the user can save the time and effort to search for the facility that requests the work by himself.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

Embodiments of the present disclosure will be described with reference to the drawings. In the present embodiment, an example in which the information processing device according to the present disclosure is applied to a system that provides a service of a vehicle will be described.

### System Configuration

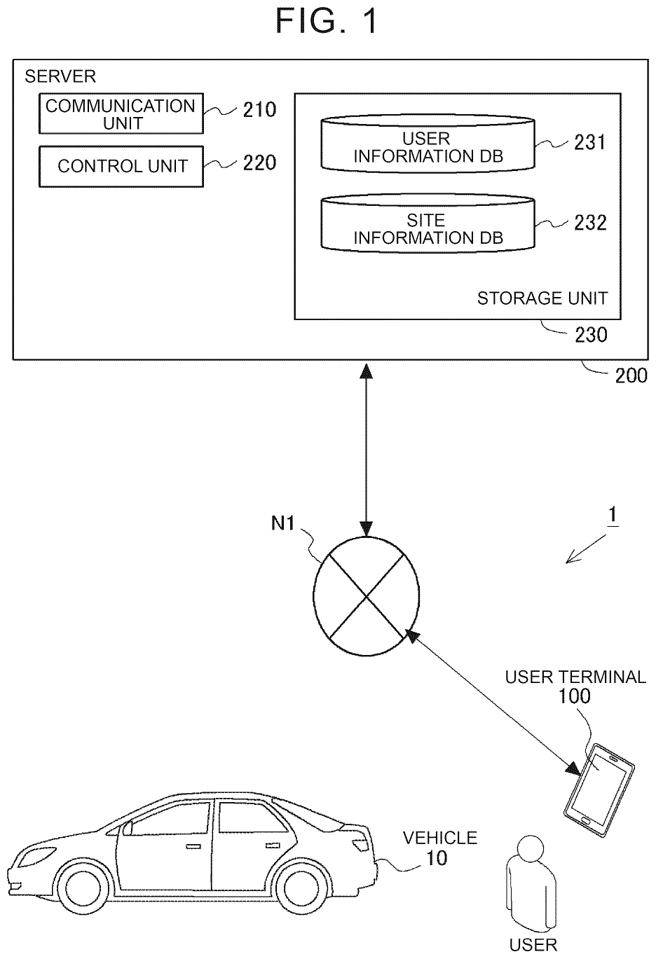

FIG. 1 is a block diagram schematically illustrating a configuration example of a system 1 according to the present embodiment. The system 1 according to the present embodiment provides a service for the vehicle 10, and includes a user terminal 100 and a server 200. In the example shown in FIG. 1, only one user terminal 100 is shown, but a plurality of user terminals 100 may be included in the system 1.

The user terminal 100 is a terminal used by a user of the vehicle 10, and is, for example, a smart phone, a tablet terminal, a wearable terminal, or a PC (Personal Computer). An application program of a browser is installed in the user terminal 100 in the present embodiment.

The server 200 is a computer operated by a service provider such as inspection or maintenance of the vehicle 10. As an example, the provider of the service may be an operator who sold or leased the vehicle 10 to the user. As another example, the service provider may be a repairer of the vehicle 10, a seller of items to be attached to the vehicle 10, or a business operator who is engaged in mounting work on the vehicle 10. The server 200 may be configured as a computer having processors such as Central Processing Unit (CPU) or Graphics Processing Unit (GPU), main storage devices such as Random Access Memory (RAM) and Read Only Memory (ROM), and secondary storage devices such as Erasable Programmable Read-Only Memory (EPROM), hard disk drives, or removable media. Operating System (OS), various programs, various tables, and the like are stored in the secondary storage device of the server 200. The processor of the server 200 loads the program stored in the auxiliary storage device into the mounting work area of the main storage device and executes the program, thereby realizing each function matching a predetermined purpose as described later. However, some or all of the functions of the server 200 may be realized by hardware circuitry such as Application Specific Integrated Circuit (ASIC) or Field Programmable Gate Array (FPGA).

The server 200 in the present embodiment is configured to be capable of implementing a Web server for interacting with the user terminal 100. The server 200 interacts with the user terminal 100 through the execution of Web server to accept designation of a work (desired work) desired by the user of the vehicle 10, and provides the user with information for recommending a facility suitable for performing the desired work. Note that the server 200 may provide the above-described services by means other than Web server. For example, a service that interacts with dedicated application software installed in the user terminal 100 according to a predetermined protocol may be executed in the server 200.

As illustrated in FIG. 1, the server 200 that realizes the above-described functions includes a communication unit 210, a control unit 220, and a storage unit 230.

The communication unit 210 is a communication interface for connecting the server 200 to a network N1. The communication unit 210 connects to a network N1 through, for example, a LAN or Wi-Fi (registered trademark), and communicates with the user terminal 100 through a network N1. The network N1 is, for example, a WAN or another communication network that is a global public communication network such as the Internet.

The control unit 220 is a software module realized by the processor of the server 200 executing a program stored in the auxiliary storage device. The control unit 220 interacts with the user terminal 100 through executing Web servers. In the present embodiment, the control unit 220 causes the browser of the user terminal 100 to display the input page. In one embodiment, the input page includes an input field of the user ID and the vehicle ID, an input field of a desired operation, and the like.

When the user ID, the vehicle ID, and the desired operation are input on the input page, the control unit 220 generates recommendation information. The recommended information is information about a facility recommended as a request destination of a desired work. In generating such recommendation information, first, the control unit 220 identifies the first facility associated with the user in accordance with the user ID and the vehicle ID entered on the entry page. The first facility is a store or the like where the user has purchased the vehicle 10. Further, the control unit 220 determines whether or not the first facility can handle the desired work. For example, the control unit 220 may determine whether or not the first facility can handle the desired work by determining whether or not the first facility has a technical level required for the desired work. The technical level required for the desired work includes the fact that the worker has equipment necessary for performing the desired work, and the fact that the worker has the skill necessary for performing the desired work. When the first facility does not correspond to the desired work, the control unit 220 identifies a second facility that can correspond to the desired work. The second facility is, for example, a facility associated with the first facility. The control unit 220 may determine whether or not the second facility can handle the desired work by determining whether or not the second facility has a technical level required for the desired work.

The first facility and the second facility are identified based on information (information registered in the user information DB 231 and information registered in the facility information DB 232) stored in the storage unit 230 described later.

When the control unit 220 finishes identifying the first facility or the second facility capable of handling the desired work, it generates recommendation information. The recommendation information is information for recommending that the desired work be requested to the first facility or the second facility. In one example, the recommendation information may include information about, for example, the name, location, and contact of the first facility or the second facility. After generating the recommendation information, the control unit 220 outputs an output page including the generated recommendation information through a Web browser of the user terminal 100.

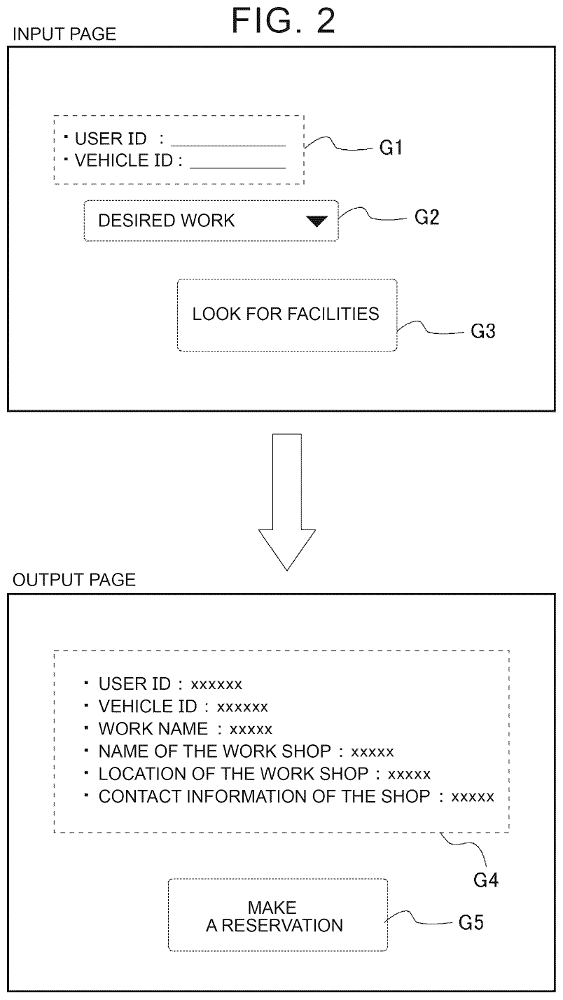

FIG. 2 is a diagram illustrating an exemplary transition of a suggested Web page according to the present embodiment. In the example illustrated in FIG. 2, the output page is output based on the content input by the user to the input page. The input page includes a field for inputting a user ID and a vehicle ID (G1 in FIG. 2), a pull-down menu for selecting a desired operation (G2 in FIG. 2), and a GUI component (G3 in FIG. 2) representing a button for requesting a search of a facility corresponding to the desired operation. The user ID is an identification symbol of the user, and is given by the control unit 220 of the server 200, for example, when the user is registered. The vehicle ID is an identification symbol of the vehicle 10, and is, for example, a number of an automobile registered number mark (license plate) corresponding to the vehicle 10. The desired operation is configured to be selectable by the user from the pull-down menu. As another example, a field for inputting a desired operation by the user may be provided, and the user may input the desired operation. The control unit 220 identifies the first facility or the second facility by the user tapping a button displayed as “search for facility” in the input page shown in FIG. 2. Then, the specified result is output to the output page.

The output-page includes a display field of the recommendation information (G4 in FIG. 2) and a GUI component (G5 in FIG. 2) representing a button for reserving the first facility or the second facility. In the example illustrated in FIG. 2, the display column of the recommendation information (G4 in FIG. 2) includes a user ID, a vehicle ID, a work name (name of the desired work), a name of the work shop (name of the facility to perform the work), a location of the work shop (location of the facility to perform the work), and a contact address of the work shop (contact address of the facility to perform the work). As another example, the first facility or the second facility may be displayed in real time (that is, even if the user does not tap a button displayed as “search for a facility”), for example, based on an input from the user. In this case, the position of the first facility or the second facility may be indicated in real time by displaying icons of the first facility or the second facility on the map. The user may tap an icon displayed on the map to display the name of the first facility or the second facility.

When the user taps a button displayed as “Reserve” through the user terminal 100 on the output page illustrated in FIG. 2, the control unit 220 transmits information on the reservation to the terminal of the corresponding facility through the communication unit 210. In one embodiment, the information related to the appointment includes information such as a user ID, a vehicle ID, and a desired operation.

Note that the configuration of the suggested Web is not limited to that shown in FIG. 2, and the displayed content can be flexibly changed according to the embodiment.

Next, the storage unit 230 is a storage area constructed in the auxiliary storage device of the server 200. In the storage unit 230 according to the present embodiment, a user information DB 231 and a facility information DB 232 are constructed. The user information DB 231 and the facility information DB 232 are relational databases constructed by the processor of the server 200 executing a program of Database Management System (DBMS).

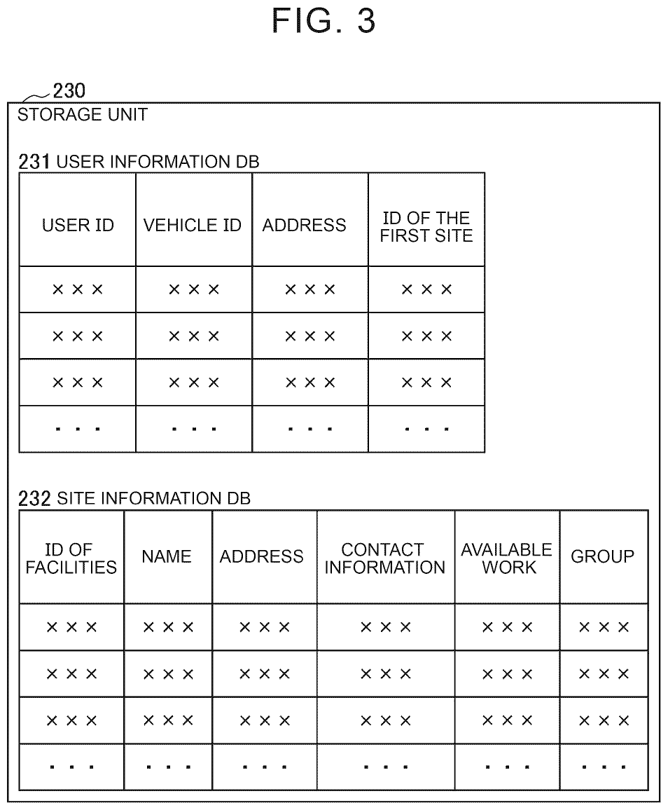

FIG. 3 is a diagram illustrating exemplary information stored in the user information DB 231 and the facility information DB 232. In the embodiment illustrated in FIG. 3, the user information DB 231 includes fields of a user ID, a vehicle ID, a location, and a first facility ID. In the user ID field, a user ID that is identification information for identifying a user is stored. Vehicle ID is stored in the Vehicle ID field. This field is identification information for identifying the vehicle 10. The location field stores the location of the user. The location of the user is, for example, an address of the user or a storage location of the vehicle 10. The information about the location of the user includes information about an address or coordinates. In the first facility ID field, facility ID that is the identity of the facility associated with the user and the vehicle 10 is stored. Stored here is facility ID corresponding to a facility where the user purchased the vehicle 10, or a facility where the user previously requested the vehicle 10 to work. The user information DB 231 stores, for example, information collected when the user purchases the vehicle 10 or when the user makes a leasing contract for the vehicle 10. As another example, for example, when the facility ID corresponding to the facility for which the user has previously requested the work for the vehicle 10 is stored in the first facility ID, the facility ID may be transmitted from the terminal of the facility that has performed the work every time the work is performed to the server 200, and the first facility ID field may be updated.

In addition, in the exemplary embodiment illustrated in FIG. 3, the facility information DB 232 includes fields of a facility ID, a name, a location, a contact address, a corresponding operation, and a group. In the facility ID field, facility ID which is the identity of the facility is stored. In the name field, information related to the name of the facility is stored. In the location field, information about the location of the facility is input. Information about the location of the facility includes information about the address or coordinates. The contact field includes information about the contact of the facility. Contacts include telephone numbers, email addresses, SNS accounts, home page addresses, and the like. The available work field includes information about the work that can be handled by the facility. In the compatible work field, for example, information on a compatible work may be input from a terminal of each facility, or information on a work corresponding to a facility included in each facility may be input. A plurality of corresponding operations may be input in the corresponding operation field. In the group field, information about the group to which the facility belongs is stored. Each facility is divided into groups corresponding to, for example, capital, group companies, and partner companies. Processing Flow

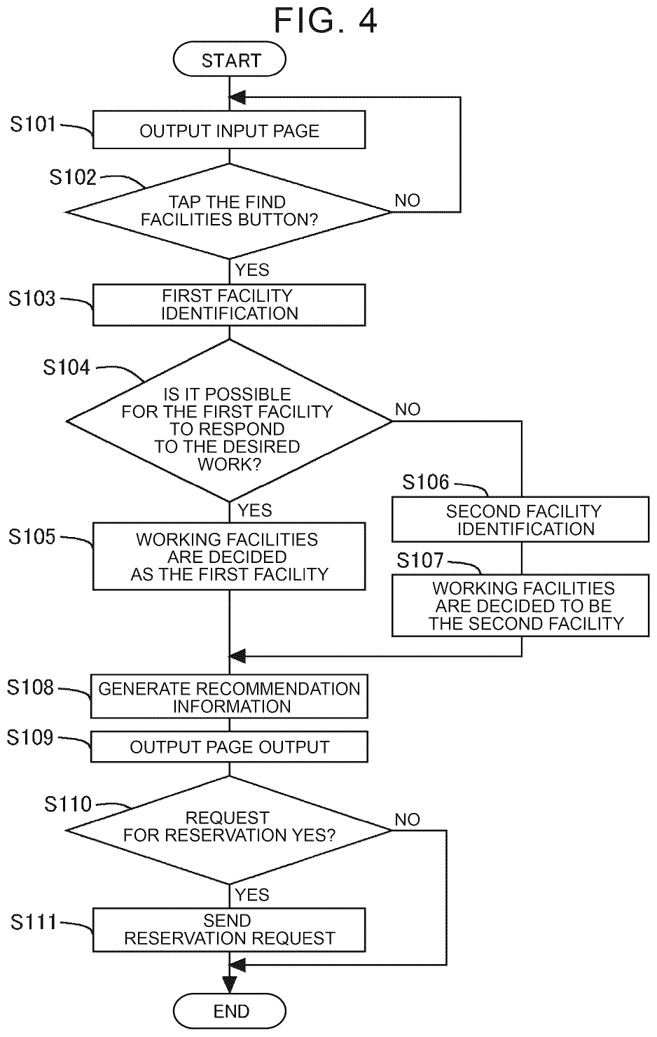

A processing flow executed by the server 200 according to the present embodiment will be described with reference to FIG. 4. FIG. 4 is a flow chart illustrating a process routine executed by the server 200 triggered by a user accessing a URL of an input page through a web browser of the user terminal 100. The execution subject of the processing routine of FIG. 4 is the processor of the server 200, and the software module of the server 200 is described as the execution subject.

When the user accesses URL of the input page through the web browser of the user terminal 100, the control unit 220 of the server 200 outputs the input page to the user terminal 100. As a result, the control unit 220 displays the input page on the web browser of the user terminal 100 (S101). As described above, the input page includes an input field of the user ID and the vehicle ID, and a pull-down menu of a desired operation. In response to the user's input to the input page, the control unit 220 receives a designation of a desired operation. Upon completion of S101 process, the control unit 220 executes S102 process.

In S102, the control unit 220 determines whether or not the user has tapped the button displayed as “search for facilities” in the input page. When the button is not tapped (negative determination in S102), the control unit 220 waits until the button is tapped. On the other hand, when the user taps the button displayed as “search for facilities” (affirmative determination in S102), the control unit 220 executes S103 process.

In S103, the control unit 220 identifies the first facility associated with the user based on the information input to the input page and the information stored in the user information DB 231. Specifically, first, the control unit 220 accesses the user information DB 231 based on the user ID and the vehicle ID input on the input page, and specifies a record corresponding to the input user ID and vehicle ID. The control unit 220 identifies the first facility by extracting the first facility ID of the identified record.

Upon completion of S103 process, the control unit 220 executes S104 process. In S104, the control unit 220 determines whether or not the first facility identified by S103 can cope with a desired task. Specifically, the control unit 220 accesses the facility information DB 232 based on the first facility identified by S103, and identifies a record corresponding to the first facility ID. The control unit 220 determines whether or not it is possible to handle the desired work according to the information stored in the correspondence work field of the identified record.

When the first facility is capable of responding to the desired work (affirmative determination in S104), the control unit 220 determines, in S105, a facility that performs the desired work (hereinafter, also referred to as a work facility) as the first facility. Upon completion of S105 process, the control unit 220 executes S108 process.

On the other hand, when the first facility is not able to cope with the desired operation (negative determination in S104), the control unit 220 identifies the second facility in S106. Specifically, the control unit 220 accesses the facility information DB 232 based on the first facility identified by S103, and extracts a record corresponding to the facility in which the same information as the first facility is stored in the group field and the facility corresponding to the desired task. Thus, a facility belonging to the same group as the first facility and corresponding to the desired work is identified.

Note that the second facility extracted from the facility information DB 232 may be limited to a facility existing within a predetermined area including the location of the user. The predetermined range is a range in which the user may move for work on the vehicle 10. The predetermined range may be a range defined by time, such as, for example, a range that can be moved in one hour, or a range defined by distance, such as, for example, a 30 km. The predetermined range may be a range registered in advance by the user or a range determined in advance by the server 200.

In a case where there are a plurality of facilities in which the same information as the first facility is stored in the group field and facilities corresponding to the desired work, the control unit 220 identifies one facility from among them. At this time, the control unit 220 may specify, for example, the facility closest to the location of the user as the second facility. Based on the information stored in the location field of the user information DB 231 and the information stored in the location field of the facility information DB 232, the facility having the shortest distance between the location of the user and the location of the facility is identified as the second facility. If the corresponding facility does not exist within the predetermined range, the second facility may be extracted, including outside the predetermined range. In a case where there is a plurality of facilities outside the predetermined range, the facility closest to the location of the user may be identified as the second facility.

Upon completion of S106 process, the control unit 220 executes S107 process. In S107, the control unit 220 determines the working facility as the second facility specified by S106. Upon completion of S107 process, the control unit 220 executes S108 process.

In S108, the control unit 220 generates recommendation data. The recommendation information is information that recommends that the desired work be requested to the first facility or the second facility. In one example, the recommendation information may include information about, for example, the name, location, and contact of the work facility. The control unit 220 extracts information about the first facility determined by S105 or the second facility determined by S107 from the facility information DB 232, and generates recommendation information. Upon completion of S108 process, the control unit 220 executes S109 process.

In S109, the control unit 220 outputs an output page including the recommendation information generated by S108 through Web browser of the user terminal 100. As illustrated in FIG. 2, the output page includes a GUI component (a G5 in FIG. 2) representing a display field of recommendation information (a G4 in FIG. 2) and a button for requesting a work establishment to reserve a desired work (a button displayed as “reserve”). Upon completion of S109 process, the control unit 220 executes S110 process.

In S110, the control unit 220 determines whether or not the user has tapped the button displayed as “reserved” through the user terminal 100. When the button displayed as “reserved” is tapped (affirmative determination in S110), the control unit 220 executes S111 process. On the other hand, when the button displayed as “reserved” is not tapped (negative determination in S110), the control unit 220 waits until the button is tapped. When the browsing of the output page is terminated without tapping the button (for example, when the execution of Web browser is terminated at the user terminal 100 or when the displaying target of Web browser of the user terminal 100 is shifted from the output page to another Web page), the control unit 220 may terminate the execution of the process routine of FIG. 4.

In S111, the control unit 220 transmits a reservation request to the terminal of the working facility through the communication unit 210. The reservation request is a request for a reservation for performing a desired work on the vehicle 10. The reservation request includes information necessary for reservation. For example, the user ID, the vehicle ID, and the desired operation may be transmitted to the terminal of the work facility. Then, the control unit 220 may acquire the date and time at which work is possible from the terminal of the work facility and present the date and time to the user terminal 100. Further, the control unit 220 may acquire information on the date and time for which work is desired from the user terminal 100, and request the terminal of the work facility to reserve the date and time. When S111 processing is finished, the control unit 220 ends the execution of this processing routine.

### Operation and Effect of Embodiments

In the above-described embodiment, when the user of the vehicle 10 designates the desired operation on the input page, the server 200 displays the output page on Web browser of the user terminal 100. As a result, the user of the vehicle 10 can know the work facility that can deal with the desired work. That is, the user of the vehicle 10 can know a facility suitable for the desired work.

In the present embodiment, the server 200 corresponds to an “information processing device” according to the present disclosure. The control unit 220 of the server 200 corresponds to a “control unit” according to the present disclosure. Further, the storage unit 230 of the server 200 corresponds to a “storage unit” according to the present disclosure.

### OTHER EMBODIMENTS

The above-described embodiment is merely an example, and the present disclosure can be appropriately modified and implemented without departing from the gist thereof. For example, processing performed by the server 200 may be performed by the user terminal 100. That is, the user terminal 100 may output a user interface screen similar to an input page, identify a first facility, determine a work facility, generate recommendation information, and output a user interface screen similar to an output page through execution of a dedicated application program. In this case, the user terminal 100 corresponds to an “information processing device” according to the present disclosure. In addition, the processor of the user terminal 100 executes a dedicated application program to achieve the “control unit” according to the present disclosure.

Also, the processes and the configurations described in the present disclosure can be appropriately combined to be implemented as long as no technical contradiction occurs. Moreover, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit configured to execute:
receiving designation of desired work, the desired work being work on a vehicle that is desired by a user;
determining whether a first facility associated with the user is able to handle the desired work;
outputting, in response to the control unit determining that the first facility is able to handle the desired work, information for recommending the first facility as a facility for performing the desired work, to a terminal related to the user; and
outputting, in response to the control unit determining that the first facility is not able to handle the desired work, information for recommending a second facility other than the first facility as the facility for performing the desired work, to the terminal related to the user.

2. The information processing device according to claim 1, wherein outputting the information for recommending the second facility includes
identifying the second facility that is present within a predetermined range including a location of the user, and
outputting, when the second facility is present within the predetermined range, information for recommending the second facility identified within the predetermined range.

3. The information processing device according to claim 2, wherein outputting the information for recommending the second facility further includes
identifying, when the second facility is not present within the predetermined range, the second facility that is present outside the predetermined range, and
outputting information for recommending the second facility identified outside the predetermined range.

4. The information processing device according to claim 1, wherein the second facility is a facility related to the first facility.

5. The information processing device according to claim 1, further comprising a storage unit that stores
information on a location of each of a plurality of facilities,
information on the desired work that is able to be handled by each of the facilities,
information on the first facility associated with the user, and
information on a location of the user, wherein outputting the information for recommending the second facility further includes
identifying the second facility nearest to the location of the user, the second facility being a facility that handles the desired work, and
outputting information for recommending the identified second facility.
